(19) United States
(12) Patent Application Publication
(10) Pub. No.: US 2006/0288401 A1
(43) Pub. Date: Dec. 21, 2006

(54) System and method for generating a Java policy file for Eclipse plug-ins

(75) Inventor: David E. Wilson, Lowell, MA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/144,288

(22) Filed: Jun. 3, 2005

(51) Int. Cl. H04L 9/00

(52) U.S. Cl. 726/1

(57) ABSTRACT

A system and method for automatically generating a Java policy file for an Eclipse Java program. A system is provided that includes an execution environment for executing the Eclipse Java program; and an extended security manager having a policy generator tool for documenting permissions required by the Eclipse Java program and for generating the Java policy file based on the documented permissions.

### BACKGROUND OF THE INVENTION

1. Technical Field

The present invention relates generally to Java policy files for Eclipse Java programs, and more specifically relates to a system and method for automatically generating Java policy files for Eclipse Java programs.

2. Related Art

When a Java 2 application is run with a Security Manager enabled, access to system resources (e.g., the file system, the network, etc.) can be restricted based on Java 2 permissions defined in a Java policy file. These restrictions are desirable to ensure that a Java program will only access the resources for which it has been configured. Unfortunately, determining the permissions a Java application needs and codifying them in the necessary Java policy format can be onerous.

Eclipse is a platform for creating and running Java applications. Application features are coded as “plug-ins” and are loaded into Eclipse. Necessarily, if these features are to be run in Eclipse with an enabled Security Manager, their necessary Java 2 permissions need to be determined and incorporated into a Java policy file. Presently, there exists no mechanism for automatically generating the necessary Java 2 permissions required by an Eclipse Java application for incorporation into a user's Java policy file. Accordingly, most Java policy files in an Eclipse environment tend to include generic permissions, which do not significantly enhance security.

SPADE (Security and Privacy Aware Development Environment) tools, such as those discussed at http://www.research.ibm.com/javasec/#Analysis analyze the Java 2 permissions requirements of a Java application by examining source code. However, such tools do not actually generate a Java policy file.

IBM's TIVOLI® Access Manager (TAM) provides authorization functionality for protected resources. It allows an administrator to set a “warning” attribute on a Protected Object Policy associated with a resource. When this attribute is set, (1) all users can access the resource, and (2) audit records are generated that detail the authorization decisions the system would have made based on the security policies in place. When TAM is running in this mode, the administrator can capture information that will allow him or her to effectively set up TAM Security Policies for the resources to be protected. However, running TAM in this manner strictly performs analysis; it does not create the necessary policies.

LOTUS NOTES™ does security analysis and policy configuration by having users interactively modify their security settings (i.e., granting necessary permissions) while the application in running. Every Lotus Notes user has an Execution Control list associated with their client. This list defines the allowed operations (e.g., access the file system or access the current database) for code developed by an application designer. When a user first accesses the features of an application, they may be prompted to allow the application to perform an operation if their current Execution Control list settings do not currently allow the requested operation. A “Yes” response to an “Allow Access” prompt results in a modification to the Execution Control list. Although this model does perform both operations of permission analysis and policy creation, it bases permissions on the application designer as opposed to a Java 2 model that bases permissions on the application code.

Accordingly, a need exists for a system and method that can automatically generate a Java policy file for an Eclipse Java program.

### SUMMARY OF THE INVENTION

The present invention addresses the above-mentioned problems, as well as others, by providing an extended Java 2 Security Manager that generates the necessary Java policy file for an Eclipse Java application based on the permissions checked when the application is run in a development environment. When an application developer wants to generate the permissions required to run the application developed for Eclipse, the developer would run the Eclipse Java application specifying that the extended Security Manager be used. A Java policy file would then be automatically generated based on, e.g., information in the permissions being checked, the Class Objects in the call stack for the checking method, the ProtectionDomain(s) of the Class Objects, and the CodeSource(s) of the ProtectionDomain(s). The resulting Java policy file could then be delivered to the user along with the Eclipse Java application so that the application could be run in Eclipse with an enabled Security Manager.

In a first aspect, the invention provides a system for generating a Java policy file for an Eclipse Java program, comprising: an execution environment for executing the Eclipse Java program; and an extended security manager having a policy generator tool for documenting permissions required by the Eclipse Java program and for generating the Java policy file based on the documented permissions.

In a second aspect, the invention provides a computer program product stored on a computer readable medium for generating a Java policy file for an Eclipse Java program, comprising: program code configured for providing an execution environment for executing the Eclipse Java program; and program code configured for providing an extended security manager having a policy generator tool for documenting permissions required by the Eclipse Java program and for generating the Java policy file based on the documented permissions.

In a third aspect, the invention provides a method for implementing a Java policy file for running an Eclipse Java program, comprising: running the Eclipse Java program in a first Eclipse execution environment that includes an extended security manager; documenting permissions required by the Eclipse Java program within the extended security manager; generating the Java policy file based on the documented permissions; and deploying the Eclipse Java program with the Java policy file.

In a fourth aspect, the invention provides a method for deploying a system for generating a Java policy file for use with Eclipse Java programs, comprising: providing a computer infrastructure being operable to: run an Eclipse Java program in a first Eclipse execution environment that includes an extended security manager; document permissions required by the Eclipse Java program within the extended security manager; generate a Java policy file based on the documented permissions; and deploy the Eclipse Java program with the Java policy file to a second Eclipse execution environment.

In a fifth aspect, the invention provides computer software embodied in a propagated signal for generating a Java policy file for an Eclipse Java program, the computer software comprising instructions to cause a computer to perform the following functions: run an Eclipse Java program in an Eclipse execution environment that includes an extended security manager; document permissions required by the Eclipse Java program within the extended security manager; and generate a Java policy file based on the documented permissions.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a block diagram of an Eclipse development and target environment utilizing an extended security manager in accordance with the present invention.

FIG. 2 depicts a flow diagram of a process for generating a Java policy file in accordance with the present invention.

### DETAILED DESCRIPTION OF THE INVENTION

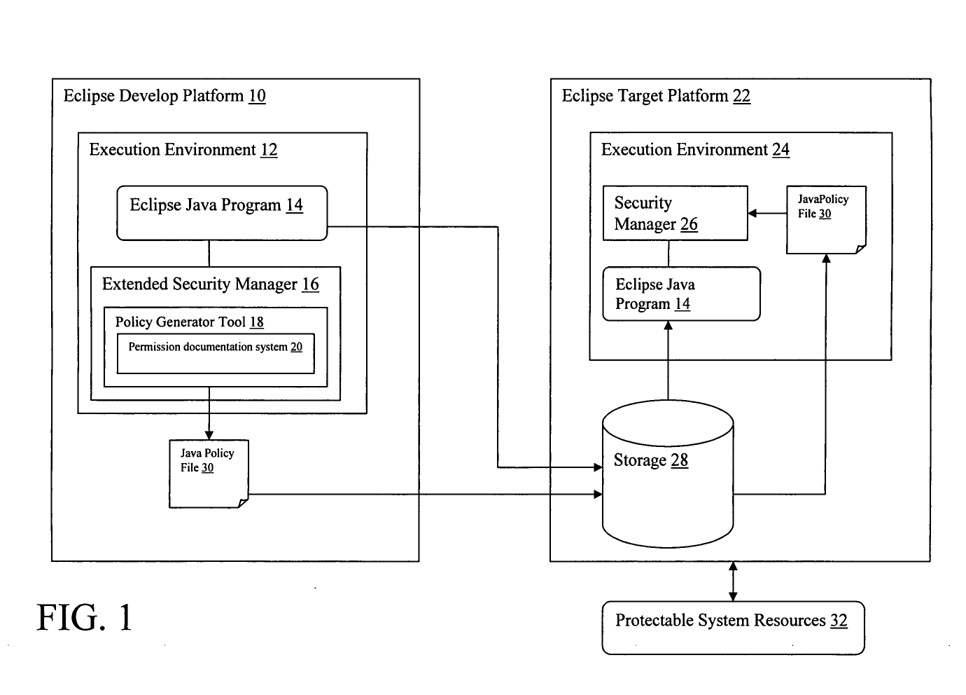

Referring now to the drawings, FIG. 1 depicts an Eclipse development platform 10 for developing an Eclipse Java program 14, and an Eclipse target platform 22 for executing the Eclipse Java program 14. The Eclipse development platform 10 includes an execution environment 12 comprising an extended security manager 16 that can automatically generate a Java policy file 30 for the Eclipse Java program 14. Execution environment 12 may include a Java virtual machine (JVM) for running the Eclipse Java program 14. Eclipse platforms are well known in the art, and are therefore not described in any further detail herein. It should be noted that while the invention is described utilizing an Eclipse development platform 10, the invention could be implemented using any other similar platform that allows for the enabling/disabling of policy generation.

Extended security manager 16 includes a policy generator tool 18 that utilizes a permission documentation system 20 to: (1) analyze and document the permissions required for running the Eclipse Java program 14, and (2) create the Java policy file 30 that grants the necessary permissions to the Eclipse Java program 14. These features can be enabled and disabled within the Eclipse Development Platform 10. It is understood that for the purposes of this disclosure, the term security manager and extended security manager encompass partially or in whole the concept of an AccessController, as the term is used in the art.

Any methodology could be utilized to generate the Java policy file 30 from within the extended security manager 16. In general, the generated Java policy file 30 will be based on, e.g., information in the permissions being checked, the Class Object(s) in the call stack for the checking method, the ProtectionDomain(s) of the Class Object(s), and the CodeSource(s) of the ProtectionDomain(s). The resulting Java policy file 30 will include entries only for the particular classes in the Eclipse Java program 14.

Once the Java policy file 30 is generated for the Eclipse Java program 14, the Eclipse Java program 16 can be deployed with the Java policy file 30 to storage 28 associated with an Eclipse target platform 22, i.e., an actual end user. From the Eclipse target platform 22, the user can execute the Eclipse Java program 14 within execution environment 24 with the security manager 26 and the Java policy file 30. Thus, Eclipse Java program 14 will be able to execute and be granted access to only those protectable system resources 32 that are required by Eclipse Java program 14.

In general, Eclipse development platform 10 and Eclipse target platform 22 may each be implemented as any type of computer system, e.g., a desktop, a laptop, a workstation, etc., having an execution environment 12, 24 that include a Java virtual machine (JVM). Moreover, platforms 10, 22 could be implemented as part of a client and/or a server. A typical computer system for implementing the platforms 10, 22 generally includes a processor, input/output (I/O), memory, and bus. The processor may comprise a single processing unit, or be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, memory may reside at a single physical location, comprising one or more types of data storage, or be distributed across a plurality of physical systems in various forms.

I/O may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. The bus provides a communication link between each of the components in the computer system and likewise may comprise any known type of transmission link, including electrical, optical, wireless, etc. Additional components, such as cache memory, communication systems, system software, etc., may be incorporated into the computer system.

Access to each platform 10, 22 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

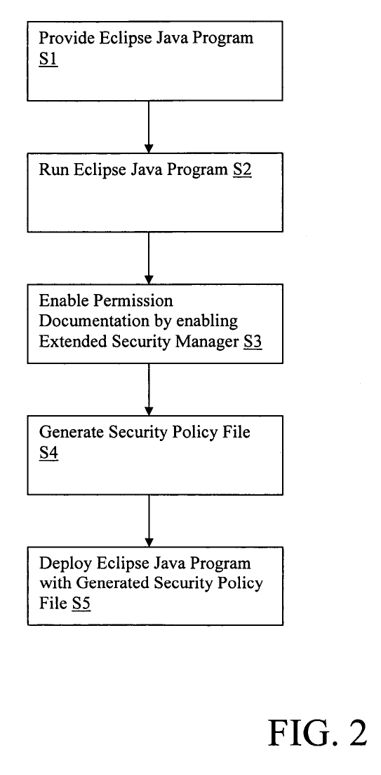

Referring now to FIG. 2, a flow diagram is provided showing a method for implementing the present invention. At step S1, an Eclipse Java program is provided, e.g., by a developer who desires to provide a Java policy file. At step S2, the Eclipse Java program is run. At step S3 (or as part of step S2), permission documentation is enabled by enabling an extended security manager, which analyzes and documents the necessary permissions required by the Eclipse Java program. At step S4, a Java policy file is generated based on the documented permissions. Finally, at step S5, the Eclipse Java program is deployed (e.g., sold, distributed, downloaded, etc.) with the generated Java policy file.

It should be appreciated that the teachings of the present invention could be offered as a business method on a subscription or fee basis. For example, an Eclipse development platform 10 could be created, maintained and/or deployed by a service provider that offers the functions described herein for customers. That is, a service provider could offer to provide automatically generated Java policy files as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for generating a Java policy file for an Eclipse Java program, comprising:
an execution environment for executing the Eclipse Java program; and
an extended security manager having a policy generator tool for documenting permissions required by the Eclipse Java program and for generating the Java policy file based on the documented permissions.

2. The system of claim 1, wherein the execution environment includes a Java virtual machine.

3. The system of claim 1, wherein the policy generator tool can be enabled and disabled within an Eclipse Development Platform.

4. The system of claim 1, wherein the Java policy file is generated based on each permission being checked, a Class Object on a call stack for a checking method, a ProtectionDomain for each Class Object, and the CodeSource of a ProtectionDomain.

5. A computer program product stored on a computer readable medium for generating a Java policy file for an Eclipse Java program, comprising:
program code configured for providing an execution environment for executing the Eclipse Java program; and
program code configured for providing an extended security manager having a policy generator tool for documenting permissions required by the Eclipse Java program and for generating the Java policy file based on the documented permissions.

6. The computer program product of claim 5, wherein the execution environment includes a Java virtual machine.

7. The computer program product of claim 5, wherein the policy generator tool can be enabled and disabled within an Eclipse Development Platform.

8. The computer program product of claim 5, wherein the Java policy file is generated based on each permission being checked, a Class Object on a call stack for a checking method, a ProtectionDomain for each Class Object, and the CodeSource of a ProtectionDomain.

9. A method for implementing a Java policy file for running an Eclipse Java program, comprising:
running the Eclipse Java program in a first Eclipse execution environment that includes an extended security manager;
documenting permissions required by the Eclipse Java program within the extended security manager;
generating the Java policy file based on the documented permissions; and
deploying the Eclipse Java program with the Java policy file.

10. The method of claim 9, comprising the further steps of:
running the Eclipse Java program in a second Eclipse execution environment with an enabled security manager; and
using the Java policy file deployed with the Eclipse Java program to control permissions to a set of required system resources.

11. The method of claim 10, wherein the first and second Eclipse execution environments include Java virtual machines.

12. The method of claim 9, wherein the documenting and generating steps can be enabled and disabled within an Eclipse Development Platform.

13. The method of claim 9, wherein the Java policy file is generated based on each permission being checked, a Class Object on a call stack for a checking method, a ProtectionDomain for each Class Object, and the CodeSource of a ProtectionDomain.

14. A method for deploying a system for generating a Java policy file for use with Eclipse Java programs, comprising:
providing a computer infrastructure being operable to:
run an Eclipse Java program in a first Eclipse execution environment that includes an extended security manager;
document permissions required by the Eclipse Java program within the extended security manager;
generate a Java policy file based on the documented permissions; and
deploy the Eclipse Java program with the Java policy file to a second Eclipse execution environment.

15. Computer software embodied in a propagated signal for generating a Java policy file for an Eclipse Java program, the computer software comprising instructions to cause a computer to perform the following functions:
run an Eclipse Java program in an Eclipse execution environment that includes an extended security manager;
document permissions required by the Eclipse Java program within the extended security manager; and
generate a Java policy file based on the documented permissions.
